(19) United States
(12) Patent Application Publication
(10) Pub. No.: US 2010/0127817 A1
(43) Pub. Date: May 27, 2010

(54) Fuse assembly and fuse therefor

(76) Inventor: Juan I. Banzo, Chihuahua (MX)

Correspondence Address: DELPHI TECHNOLOGIES, INC;LEGAL STAFF - M/C 483-400-402, 5725 DELPHI DRIVE, PO BOX 5052, TROY, MI, 48007, US

(21) Appl. No.: 12/313,899

(22) Filed: Nov. 25, 2008

(51) Int. Cl. H01H 85/02

(52) U.S. Cl. 337/227; 337/198; 337/283

(57) ABSTRACT

A fuse assembly comprises a plurality of fuses and a fuse holder that has a plurality of passages extending through the fuse holder. A fuse chamber at one end of each passage receives one of the fuses. A terminal cavity at an opposite end of each passage communicates with the fuse chamber for plugging a terminal into the terminal chamber from an opposite end of the fuse holder. Each of the fuses has a fuse body and a terminal blade portion at each side of the fuse body. The terminal blade portion at one side of the fuse body has an exposed lower tip adjacent the terminal cavity for electrical connection to a terminal inserted into the terminal cavity, and the terminal blade portion at an opposite side of the fuse body has an exposed upper tip for electrical connection to a terminal inserted into the fuse chamber.

### BACKGROUND OF THE INVENTION

This invention relates to a fuse assembly and a fuse for the fuse assembly.

U.S. Pat. No. 4,580,124 granted to John M. Bozoni Apr. 1, 1986 discloses a conventional flat fuse 2 comprising a fuse element 4 and a synthetic plastic housing 6. The fuse element 4 which is secured in the housing 6 has two terminal blade portions 8 extending downwardly from the housing in spaced, juxtaposed, parallel relationships.

U.S. Pat. No. 5,645,443 granted to Thomas Schaller Jul. 8, 1997 discloses a fuse assembly comprising a plurality of conventional flat fuses 18 disposed in housing 16 that may comprise two housing halves. Each of the flat fuses 18 also has two terminal blade portions projecting downwardly from a fuse housing. A potential distributor 10 which includes a plurality of blade terminals 12, 12′ is disposed in the housing 16. Each of the blade terminals 12, 12′ is connected to one of the terminal blade portions of one of the flat fuses 18 by a contact strip 17 that includes a plurality of sleeves. Each sleeve connects one of the blade terminals 12, 12′ to one of the terminal blade portions of one of the flat fuses 18. The other terminal blade portion of each of the flat fuses 18 is connected to an electrical lead 39 via an individual flat plug sleeve 19.

Bussed electrical centers having conventional flat fuses are also known. The flat fuses are enclosed in a housing having a lower housing and a removable upper cover that provides access to the fuses for replacement. The fuses are typically plugged into the lower housing and then enclosed by attaching the removable upper cover.

U.S. Pat. No. 6,062,916 granted to Joseph H. Gladd et al. May 16, 2000 also discloses a bussed electrical center 8 having an upper housing 10 for receiving conventional flat fuses (not shown). The electrical center 8 has a printed circuit board 14 sandwiched between upper housing 10 and a lower housing 12 that has a plurality of bays for receiving wiring harness connectors. The printed circuit board 14 carries pass through terminals 16 for connecting terminals of the conventional fuses to mating terminals in the wiring harness connectors.

In either of the above cases, the flat fuses are plugged into the bussed electrical connector or the fuse assembly so that one of the blade terminal portions is plugged into a bussed electrical connector that is either connected to a common power source or a common ground while the other blade terminal portion is plugged into an electrical connector that is attached to an electrical device via an electrical lead and/or one or more electrical connectors. See for instance, the Schaller '443 patent described above where one blade terminal portion of each of the fuses 18 is plugged into a bussed electrical connector (a power strip 15, 20 via sleeves 17) and the other blade terminal portion of each of the fuses 18 is plugged into an electrical lead 39 that is attached to an electrical device or load.

### SUMMARY OF THE INVENTION

The fuse assembly of the invention provides at least one of the following improvements in comparison to the known bussed electrical connectors and fuse assemblies of the type discussed above having conventional flat fuses wherein the two terminal blade portions of the flat fuses extend downwardly from a fuse housing in the same direction and plug into two electrical sleeves or female terminals that are arranged side by side in a spaced parallel relationship.

The fuse assembly reduces the distance required between the centerlines of the electrical sleeves or female terminals (and the conductor cables attached to the electrical sleeves or female terminals, if any) that plug onto the terminal blade potions of the flat fuses.

The fuse assembly reduces the footprint and/or height of the housing that holds the flat fuses resulting in weight and/or material savings.

The fuse assembly reduces the travel distance required for plugging the flat fuses and other components into the fuse assembly.

The fuse assembly increases the interior packaging space available for bussing component or components of the fuse assembly.

### BRIEF DESCRIPTION OF THE DRAWINGS

FIG. 1 is a front view of a fuse assembly that illustrates an embodiment of the invention;

FIG. 2 is side view of the fuse assembly shown in FIG. 1;

FIG. 3 is a fragmentary perspective view of the fuse assembly shown in FIG. 1;

FIG. 4 is another view of the fuse assembly shown in FIG. 1 with the housing removed to show internal relationships;

FIG. 5 is a section taken substantially along the line 5-5 of FIG. 3 looking in the direction of the arrows; and

FIG. 6 is a perspective view of one of the fuses.

FIG. 7 is a perspective view of a battery connector having a fuse assembly that embodies the invention;

FIG. 8 is a side view of the battery connector shown in FIG. 7, and

FIG. 9 is a section taken substantially along the line 9-9 of FIG. 8 looking in the direction of the arrows.

### DETAILED DESCRIPTION OF A PREFERRED ENVIRONMENT

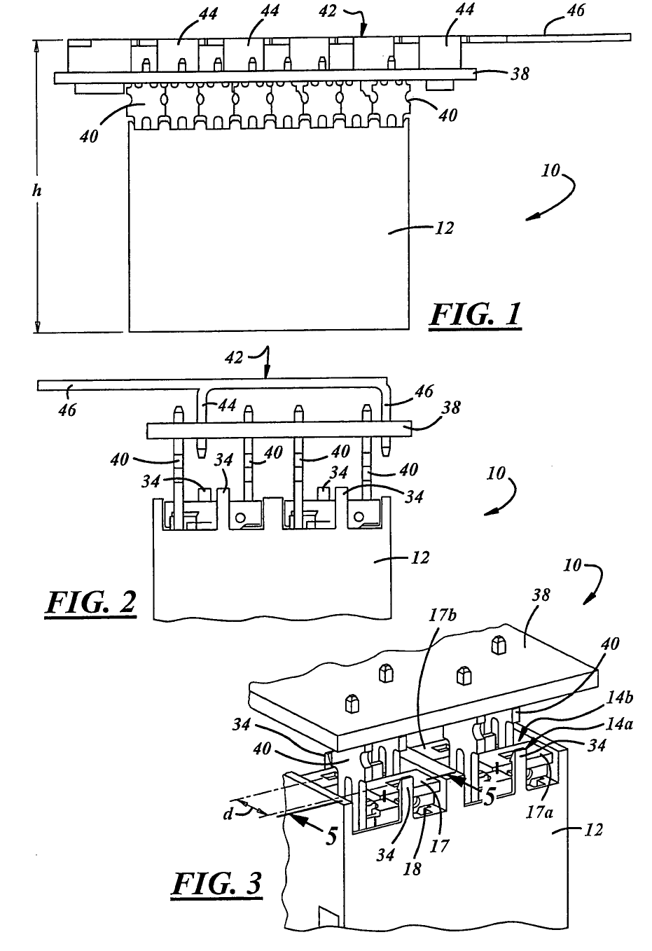

Referring now to FIG. 1, a fuse assembly 10 that illustrates an embodiment of the invention is disclosed. Fuse assembly 10 comprises a fuse holder 12 having a plurality of passages 14 that extend through the fuse holder and that are arranged in two rows. However, it should be understood that the fuse holder 12 may have any number of passages arranged in any number of rows.

Each passage 14 has a fuse chamber 16 at one end of the fuse holder 12. The fuse chamber 16 is open at the one end of the fuse holder 12 for plugging a fuse 17 into the fuse chamber 16 from the one end of the housing.

Each passage 14 has a terminal cavity 18 at an opposite end of the fuse holder 12 that communicates with fuse chamber 16 and that opens at an opposite end of the terminal housing 12 for plugging an electrical sleeve or female terminal 19 into the fuse holder 12 from an opposite end of the fuse holder 12. Each electrical sleeve or female terminal 19 may be attached to the end of an electrical lead 20 in a conventional manner for connecting the electrical sleeve or female terminal 19 to an electrical device or load.

Each of the flat fuses 17 comprises an electric insulator fuse body 22 and two terminals 24 and 26. Terminals 24 and 26 are at opposite sides of the fuse body 22 and substantially parallel to each other. Terminals 24 and 26 project from portions of the fuse body 22 in opposite directions in a substantially parallel manner. That is terminal 24 projects upward and terminates in an exposed upper tip 28 while terminal 26 projects downward and terminates in an exposed lower tip 30. Terminals 24 and 26 which are at opposite sides of the fuse body 22 are preferably within the overall height of the fuse body 22 as best shown in FIG. 6. Terminals 24 and 26 have respective ends that are embedded or otherwise disposed in the fuse body 22 and that are connected by a fusible link 32 that is disposed within the fuse body 22. Flat fuse 17 operates in a well know manner to limit current flow between terminals 24 and 26 as determined by the characteristics of fusible link 32.

Each of the flat fuses 17 is plugged into the fuse chamber 16 of a passage 14 with one of the fuse terminals 24 or 26 projecting down with its tip 28 or 30 aligned with and juxtaposed the terminal cavity 18 of the passage 14. The other fuse terminal 24 or 26 projects up and is accessible via the upper open end of the fuse chamber 16 as best shown in FIG. 5. Each of the flat fuses 17 is preferably retained in the fuse chamber 16 for instance by flex arms 34 of the terminal body 12 or some other suitable retaining means. As shown in FIGS. 2, 3 and 5, each of the fuse chambers 16 have two flex arms 34 engaging the top of a respective flat fuse. The flex arms 34 are offset laterally and engage the top at opposite sides.

Fuse assembly 10 further comprises a bussed electrical connector 36 which is illustrated as a sub-assembly comprising a circuit board 38 that carries a plurality of terminals 40 that are arranged to plug onto the fuse terminals 24 or 26 of the flat fuses 17 in fuse chambers 16 that project upward. Terminals 40 are illustrated as tuning fork type terminals, however, any electrical sleeve or female terminal that mates with the fuse terminals 24 or 26 of the flat fuses may be used.

Fuse assembly 10 further comprises a stamped metal distributor strap 42 that has a plurality of connector feet 44 that plug into slots of the circuit board 20 for connecting the distributor strap 42 to the circuit board mechanically and electrically. The metal distributor strap 42 is connected to each of the terminals 40 in any well known manner, for instances by traces of copper or copper alloy (not shown) on the circuit board 38 connecting the feet 44 to the terminals 40 electrically. The distributor strap 42 includes a connector tab 46 at one end for connecting the distributor strap 42 to a power source such as a vehicle battery (not shown).

Two types of passages 14 with eccentric terminal cavities 18 are preferably used. In one, the terminal cavity is offset to the right while in the other the terminal passage is offset to the left.

Each row of passages 14 can be alternated so that a passage of the first type having a terminal cavity offset laterally in one direction is followed by a passage of the second type having a terminal cavity offset laterally in an opposite direction. For instance as shown in FIG. 3, the front passage 14a in the right hand row has a terminal cavity 18 that is offset laterally to the right while the second passage 14b in the right hand row behind the front terminal passage 14a has a terminal cavity 18 that is offset to the left. Thus the right front fuse 17a is inserted into the right front passage 14a so that the fuse terminal 24 projects upward and the fuse terminal 26 projects downward into the right front terminal passage 18 to engage the terminal 19 as shown in FIG. 5. The second fuse 17b is then inserted upside down (or rotated 180 degrees about a vertical axis) and inserted into the second terminal passage 16b so that the fuse terminal 26 projects upward and the fuse terminal 24 projects downward into the second terminal passage 18 which is offset to the left to engage another terminal 19.

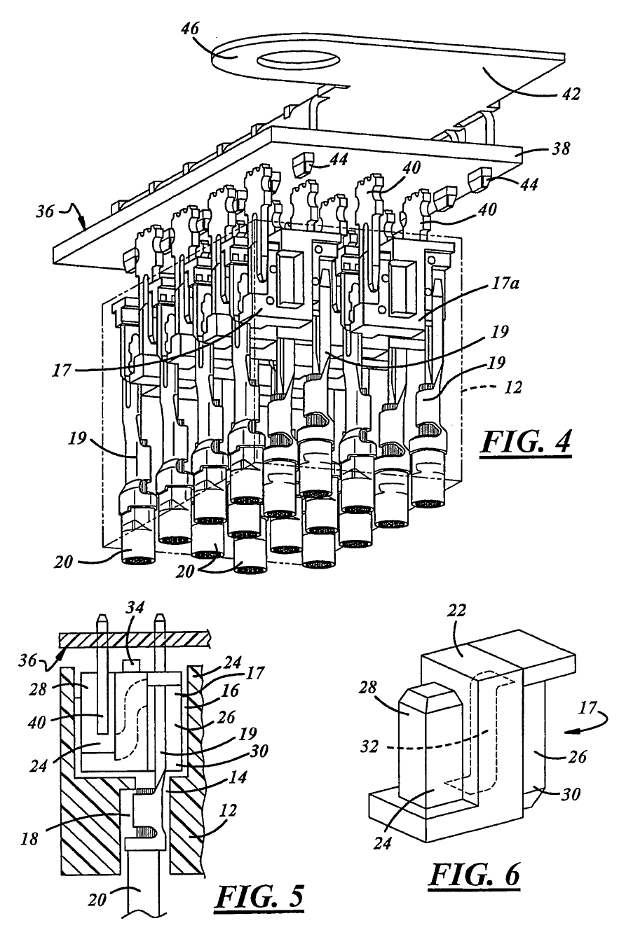

For fuse holders having more than two passages or more than one row, this right/left alternating arrangement may be repeated in each row as indicated in figure 4 where the fuse holder 12 has been removed to show the arrangement of the flat fuses 17, the terminals 19 that are plugged up into the terminal cavities of the fuse holder 12 and the terminals 40 that are plugged down into the fuse chambers 16 more clearly. Where more than one row is used, the side-by side passages are preferably offset in the same direction as shown in FIG. 4. This right/left alternating arrangement provides several advantages. The spacing between the centerlines of the terminals 19 engaging the flat fuses 17 from one direction (and the conductors 20 as well, if any) and of the spacing between the centerlines of the terminals 40 engaging the fuses 17 from an opposite direction can be reduced in a longitudinal and/or a lateral direction. This in turn results in a smaller foot print for the terminal housing 12. Moreover, the height of the terminal housing 12 can be reduced due to the fuse terminals 24 and 26 being located at the opposite sides of the fuse body 22 and within the height of the fuse body 22. The smaller foot print and reduced height of the terminal housing 12 each result in a saving in weight and material which is even better if the footprint and the height of the fuse holder 12 are both reduced.

The fuse assembly 10 of the invention also reduces the travel distance required for plugging the components into the fuse assembly 10 in comparison to current designs where the printed circuit board is located between conventional flat fuses and wiring harness terminals which require an intermediate terminal such as the pass through terminals 16 shown in the Gladd et al. '916 patent. This is turn reduces the height “h” of the fuse assembly 10 shown in FIG. 1.

The fuse assembly 10 also may increase the interior packaging space available for the bussing sub-assembly by reducing the distance “d” between the fuse centerline as best shown in FIG. 3.

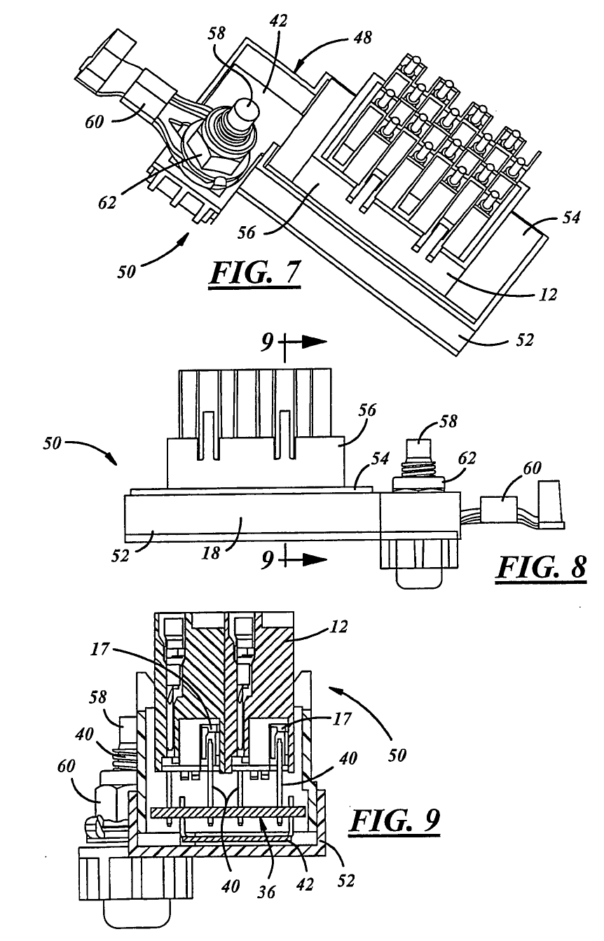

Fuse assembly 10 may also include a housing 48 for the bussed electrical connector sub-assembly 36 as shown for example in FIGS. 7, 8 and 9 in connection with a battery connector 50 which comprises a lower housing 52 and an upper housing 54 that houses the bussed electrical connector sub-assembly 36 as best shown in FIG. 9. Upper housing 54 has a socket portion 56 that receives the fuse holder 12 and flexible lock arms 58 that retain the fuse holder 12. The flat fuses 17 carried by the fuse holder 12 plug into the circuit board terminals 40 when the terminal housing 12 is plugged into the upper housing 54. The lower housing 52 of the battery connector 50 supports a stud 58 that is connected to the connector tab 46 of the distributor strap 46 that is inside the housing of the battery connector formed by lower and upper housings 52 and 54. Stud 58 is secured to a battery cable terminal 60 by a nut 62.

While the forms of the invention herein disclosed constitute presently preferred embodiments, many others are possible. It is not intended herein to mention all of the possible equivalent forms or ramifications of the invention. It is understood that the terms used herein are merely descriptive rather than limiting and that various changes may be made without departing from the spirit or the scope of the invention.

I claim:

1. A fuse assembly comprising:
a plurality of fuses, and
a fuse holder, the fuse holder having a plurality of passages extending through the fuse holder,
a fuse chamber at one end of each passage that opens at one end of the fuse holder for receiving one of the fuses that is plugged into the fuse chamber from the one end of the fuse holder;
a terminal cavity at an opposite end of each passage that communicates with the fuse chamber and that opens at an opposite end of the fuse holder for plugging a terminal into the fuse holder from an opposite end of the fuse holder;
each of the fuses having a fuse body and a terminal at each side of the fuse body,
the terminal at one side of the fuse body having an exposed lower tip adjacent the terminal cavity for electrical connection to a terminal inserted into the terminal cavity, and
the terminal at an opposite side of the fuse body having an exposed upper tip adjacent the one end of the of the fuse holder for electrical connection to a terminal inserted into the fuse chamber from the one end of the fuse holder.

2. The fuse assembly of claim 1 wherein the plurality of passages are arranged in at least one row having at least two passages and wherein the at least two passages that are arranged in the at least one row so that a passage of a first type having a terminal cavity offset in one lateral direction is followed by a passage of a second type having a terminal cavity offset in offset in an opposite lateral direction.

3. The fuse assembly of claim 1 wherein the plurality of passages are arranged in at least one row and wherein the plurality of passages that are arranged in the at least one row comprise a passage of a first type having a terminal cavity offset in one lateral direction followed by a passage of a second type having a terminal cavity offset in offset in an opposite lateral direction.

4. The fuse assembly of claim 1 wherein the plurality of passages are arranged in a plurality of rows each having a plurality of passages and wherein the plurality of passages in each row comprise a passage of a first type having a terminal cavity offset in one lateral direction alternated with a passage of a second type having a terminal cavity offset in offset in an opposite lateral direction.

5. The fuse assembly of claim 4 wherein the plurality of passages in the plurality of rows are arranged with passages of the first type are arranged side by side and the passages of the second type are arranged side by side.

6. The fuse assembly of claim 1 further comprising a bussed electrical connector that has a plurality of terminals that extend into respective ones of the fuse chambers and that are electrically connected to respective ones of the terminal of the fuses.

7. The fuse assembly of claim 6 wherein the bussed electrical connector is a sub-assembly comprising a metal distributor strap.

8. The fuse assembly of claim 7 wherein the bussed electrical connector sub-assembly comprises a circuit board that supports the metal distributor strap and the plurality of terminals that extend into respective ones of the fuse chambers.

9. The fuse assembly of claim 8 further comprising a housing receiving the bussed electrical connector sub-assembly, the housing having a socket portion receiving the fuse holder so that the plurality of terminals extend into the respective ones of the fuse chambers and are electrically connected to the respective ones of the fuse terminals.

10. The fuse assembly of claim 1 wherein each of the fuses comprise an electric insulator fuse body, a first terminal and a second terminal, the first terminal and the second terminal having ends disposed in the insulator fuse body that are connected by a fusible link disposed in the insulator fuse body, the first terminal being located on one side of the insulator fuse body and having an exposed upper tip and the second terminal being located at an opposite side of the insulator fuse body and having an exposed lower tip.

11. A fuse comprising an electric insulator fuse body, a first terminal and a second terminal, the first terminal and the second terminal having ends disposed in the insulator fuse body that are connected by a fusible link disposed in the insulator fuse body, the first terminal being located on one side of the insulator fuse body and having an exposed upper tip and the second terminal being located at an opposite side of the insulator fuse body and having an exposed lower tip.
